(19) United States
(12) Patent Application Publication
(10) Pub. No.: US 2025/0245460 A1
(43) Pub. Date: Jul. 31, 2025

(54) IMAGE FORMING APPARATUS, IMAGE FORMING APPARATUS CONTROL METHOD, AND STORAGE MEDIUM

(71) Applicant: CANON KABUSHIKI KAISHA, Tokyo (JP)

(72) Inventor: HIROYUKI SHIOIRI, Kanagawa (JP)

(21) Appl. No.: 19/036,898

(22) Filed: Jan. 24, 2025

(30) Foreign Application Priority Data
Jan. 25, 2024 (JP) 2024-009202

(51) Int. Cl. G06K 15/02; B41J 2/21; B41J 29/393

(52) U.S. Cl. CPC G06K 15/027; B41J 2/2103; B41J 29/393; B41J 2029/3935; G06K 2215/0094

(57) ABSTRACT

The disclosure aims at achieving highly-accurate spot color correction. An embodiment of the present invention is an image forming apparatus including: a reception unit to receive first Lab values of a target color and ΔLab values; a generation unit to generate image data of a layout where multiple patch images each containing an image section filled with a single color are arranged based on the first Lab values and the ΔLab values using a printer profile; a formation unit to form the multiple patch images on a print medium based on the image data of the layout; and an obtaining unit to measure a color in the image section of each of the multiple patch images formed by the formation unit and thereby obtain second Lab values for each of the multiple patch images.

### BACKGROUND

### Field

The present disclosure relates to an image forming apparatus, an image forming apparatus control method, and a storage medium, and in particular to a color correction technique by printing and measuring a spot color.

### Description of the Related Art

There are some conventional printing apparatuses having a spot color printing function to print a specific color, for example, a desired corporate color with high reproducibility. However, some printing apparatus for spot color printing is unable to reproduce a desired color due to color characteristics of the printing apparatus. As a function to solve the above problem, there is a spot color correction function that enables color reproduction of a spot color according to the characteristics of a printing apparatus by measuring a color on a print medium on which the spot color is printed.

Regarding patches to be printed for spot color correction, Japanese Patent Laid-Open No. 2006-157294 discloses a technique for generating pixel values of patches from 8 lattice points surrounding a target value in a B2A tag of an ICC profile. The B2A tag of the ICC profile is, for example, a table for converting Lab of spot color values to CMYK of a color space for a printing apparatus.

### SUMMARY

However, in Japanese Patent Laid-Open No. 2006-157294, even in a case where a color desired by a user is present among colors exhibited with the surrounding pixel values of the patches printed for spot color correction, the user is not allowed to designate the pixel values of the patch, which poses a problem that the spot color correction with a desired accuracy cannot be achieved.

In view of the aforementioned problem, the present disclosure has an object to achieve highly-accurate spot color correction.

An embodiment of the present invention is an image forming apparatus including: a reception unit configured to receive first Lab values of a target color and ΔLab values; a generation unit configured to generate image data of a layout in which a plurality of patch images are arranged based on the first Lab values and the ΔLab values using a printer profile, the plurality of patch images each containing an image section filled with a single color; a formation unit configured to form the plurality of patch images on a print medium based on the image data of the layout; an obtaining unit configured to measure a color in the image section of each of the plurality of patch images formed by the formation unit and thereby obtain second Lab values for each of the plurality of patch images; a determination unit configured to determine the patch image, the second Lab values for which are closest to the first Lab values of the target color, among the plurality of patch images; and a setting unit configured to set CMYK values of the patch image determined by the determination unit as correction values for a spot color.

Further features of the present invention will become apparent from the following description of exemplary embodiments with reference to the attached drawings.

### BRIEF DESCRIPTION OF THE DRAWINGS

FIG. 1 is a diagram presenting a structure of an image forming system;

FIG. 2 is a block diagram of the image forming apparatus;

FIG. 3 shows GUI screens for spot color correction (color matching);

FIG. 4 is a diagram illustrating a relationship between a target color and surrounding colors;

FIG. 5 is a diagram illustrating patch images printed by using device colors;

FIG. 6 is a flowchart of spot color correction (color matching) processing according to a first embodiment;

FIG. 7 is a flowchart of spot color correction (color matching) processing according to the first embodiment;

FIG. 8 is a diagram showing the relationship of FIG. 8A and FIG. 8B, and FIG. 8A and FIG. 8B collectively show a flowchart of spot color correction (color matching) processing according to a second embodiment; and

FIGS. 9A and 9B present GUI screens on which result of spot color correction (color matching) are displayed.

### DESCRIPTION OF THE EMBODIMENTS

Hereinafter, embodiments according to the present disclosure will be described in detail. It should be noted that the constituent elements described below are presented just as an example, and are not intended to limit the present disclosure to these.

### First Embodiment

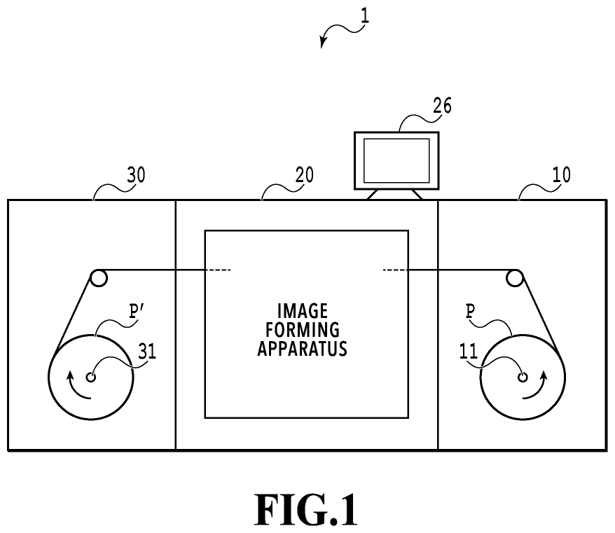

FIG. 1 is a diagram illustrating a structure of an image forming system 1 according to the present embodiment. The image forming system 1 forms an image on continuous roll paper (also called continuous paper) P used in the present embodiment on which image formation is possible. The image forming system 1 includes a paper feeder apparatus 10, an image forming apparatus 20, and a winding apparatus 30 which are connected together in this order from an upstream side along a conveyance direction of the roll paper P. The paper feeder apparatus 10 is an apparatus to feed the roll paper P to the image forming apparatus 20. The paper feeder apparatus 10 rotates a paper core of the roll paper P around a rotation shaft 11, thereby conveying the roll paper P wound around the paper core to the image forming apparatus 20 at a constant speed via multiple rollers (such, for example, as a conveyance roller and a paper feeding roller). The image forming apparatus 20 forms an image on the roll paper P fed from the paper feeder apparatus 10. The image forming apparatus 20 conveys the roll paper P on which the image is formed to the winding apparatus 30. The winding apparatus 30 is an apparatus to wind up the roll paper P conveyed from the image forming apparatus 20 around a paper core in a roll form. As illustrated in FIG. 1, for example, the winding apparatus 30 holds the roll paper P wound around the paper core of a rotation shaft 31 in the roll form. The winding apparatus 30 rotates the paper core around the rotation shaft 31 to wind up, as a roll paper print product P′, the roll paper P conveyed to the paper core around the paper core at a constant speed via multiple rollers (such, for example, as a conveyance roller and a paper delivery roller). The present embodiment is described herein in a mode where an image is formed (printed) on paper as a print medium. Instead, the present embodiment may be applied to an image forming apparatus to perform printing on a print medium other than paper.

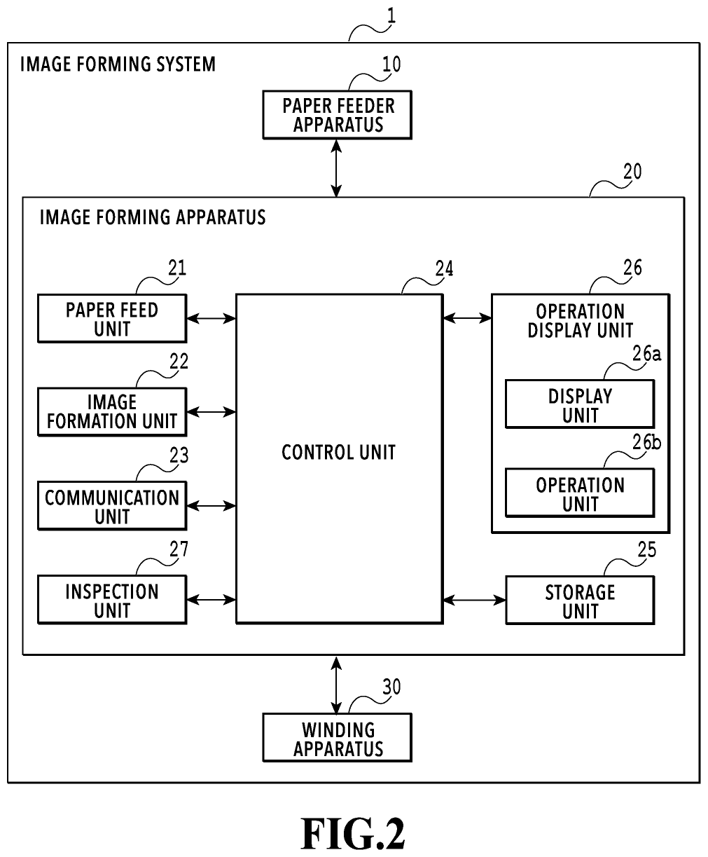

Next, a structure of the image forming apparatus will be described in detail by using FIG. 2. FIG. 2 is a functional block diagram illustrating a structure related to control of the image forming apparatus 20. In FIG. 2, the paper feeder apparatus 10 and the winding apparatus 30 are presented as external apparatuses of the image forming apparatus. As illustrated in FIG. 2, the image forming apparatus 20 includes, for example, a paper feed unit 21, an image formation unit 22, a communication unit 23, a control unit 24, a storage unit 25, an operation display unit 26, and an inspection unit 27. The paper feed unit 21 is a conveyance mechanism of the roll paper P inside the image forming apparatus 20. For example, using multiple rollers, the paper feed unit 21 conveys the roll paper P conveyed from the paper feeder apparatus 10 to the image formation unit 22 and then conveys the roll paper P after passing through the image formation unit 22 to the winding apparatus 30. The image formation unit 22 forms an image on the roll paper P fed from the paper feeder apparatus 10 based on print data for which an output command is received. The image formation unit 22 conveys the roll paper P on which the image is formed to the winding apparatus 30. The communication unit 23 includes a communication control card such, for example, as a local area network (LAN) card. The communication unit 23 transmits and receives various types of data to and from an external apparatus 211 (for example, a personal computer) connected to a communication network such as a LAN or a wide area network (WAN). The control unit 24 includes, for example, a central processing unit (CPU), a random access memory (RAM), and so on. The CPU in the control unit 24 reads various programs stored in the storage unit 25 such as a system program and a processing program, expands the programs on the RAM, and executes various types of processing according to the expanded programs. For example, the control unit 24 is capable of performing image formation processing to execute an image formation job (hereinafter referred to as a job) according to a user's instruction. In the image formation processing, the control unit 24 performs, for example, processing of converting a received PDF job to images in cyan, magenta, yellow, and black colors, which are printer device-dependent colors, according to a printer profile. In the image formation processing, the control unit 24 can assign, to a spot color name contained in the received PDF job, specific Lab values of device-independent colors or specific CMYK values of the device-dependent colors. A user is allowed to designate the specific Lab values or CMYK values via the operation display unit 26. The printer device-dependent colors refer to colors dependent on the image forming apparatus 20.

The storage unit 25 includes, for example, a non-volatile semiconductor memory (a so-called flash memory), a hard disk drive (HDD), or the like. The storage unit 25 stores various programs including the system program and the processing program to be executed by the control unit 24 and various types of data necessary for executing these programs. Although the image forming apparatus 20 in the present embodiment functions as an information processing apparatus having the control unit 24, a separate information processing apparatus connected to the image forming apparatus 20 may function as the control unit 24.

The operation display unit 26 includes, for example, a liquid crystal display (LCD) equipped with a touch panel and includes a display unit 26a and an operation unit 26b. The display unit 26a displays various types of information on a display screen according to a display control signal input from the control unit 24. The operation unit 26b includes various operation keys such as ten keys and a start key, receives various input operations by the user, and outputs operation signals to the control unit 24. The operation display unit 26 is used, for example, for setting separation information or doing the like in the case of executing a job. The separation information is set in page information contained in the job, in the case where a roll paper print product P′ has to be sorted into multiple volumes for delivery, as information indicating each position where to additionally insert a separator page into pages to be printed. The separation information is inserted in advance before job execution. The separation information is generated by the user optionally setting any of conditions such as the number of print pages, the number of print copies, a print length, a print weight, and a print diameter. Here, the print weight means a weight of the product P′. The print diameter means the diameter of the print product P′.

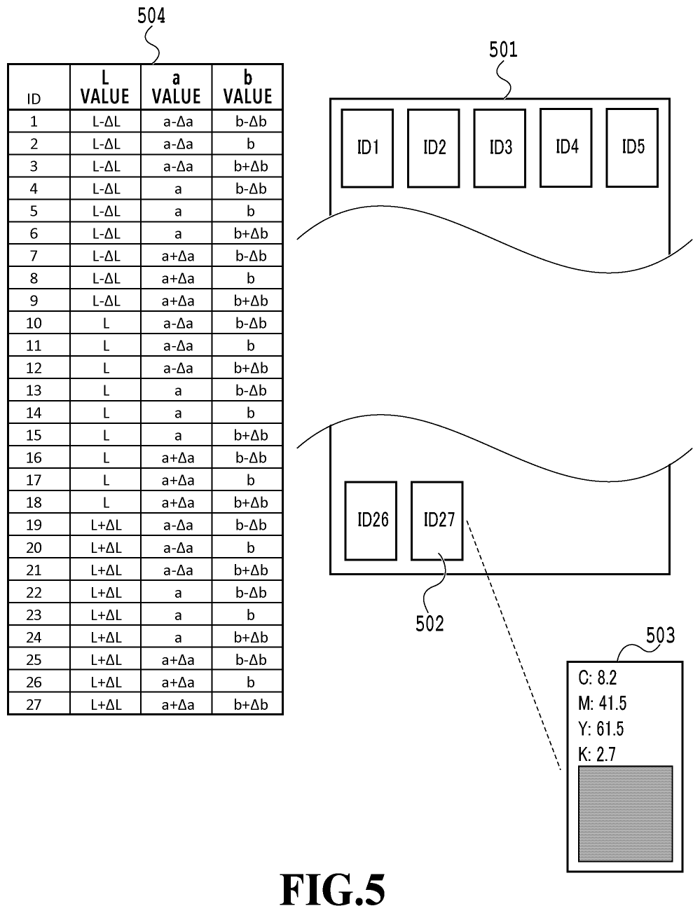

Next, description will be given of an operation in the case where the image forming apparatus 20 performs the image formation processing on the roll paper P. First, using an external apparatus, the user creates data of a job, makes print settings and a delivery volume number setting for the job, and transmits these types of information to the image forming apparatus 20 via the communication network. The control unit 24 in the image forming apparatus 20 receives the data of the job and a job ticket transmitted from the external apparatus via the communication unit 23, the job ticket containing the print setting information and the delivery volume number setting for the job, and the like. The inspection unit 27 is an apparatus configured to check whether or not an image is printed on the roll paper without having any ejection defect. The inspection unit 27 causes the image forming apparatus 20 to print a pattern for an ejection defect inspection on a sheet, reads the printed pattern by using a scanner, and checks whether or not the read image has image quality degradation. Then, in the case where image quality degradation is detected, the inspection unit 27 determines that any of nozzles causes an ejection defect and stops the image forming apparatus 20. The inspection unit 27 has a color-measurement function, and measures a color in an image printed based on patch data by the image forming apparatus 20 using the device colors, thereby obtaining color-measurement values (Lab) of the color. The image printed by the image forming apparatus 20 based on the patch data using the device colors will be described later in detail (see a layout 501 in FIG. 5).

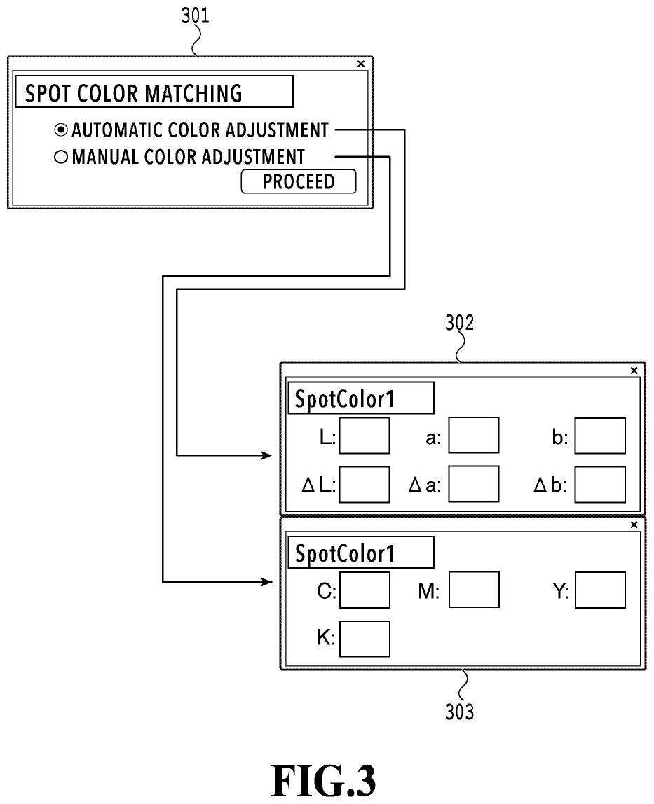

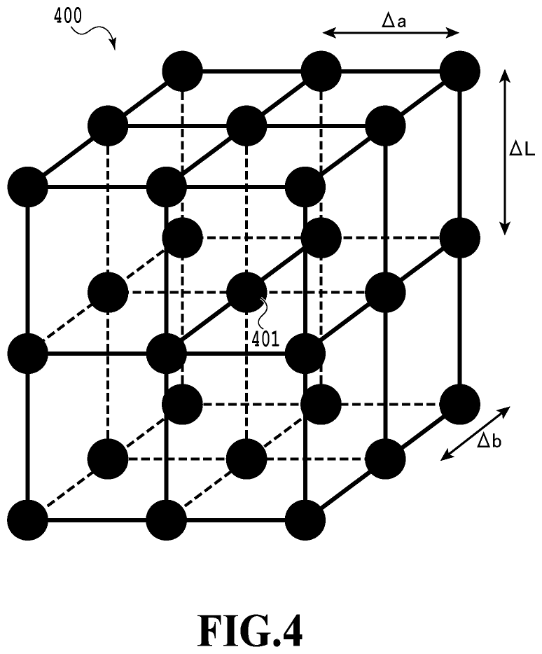

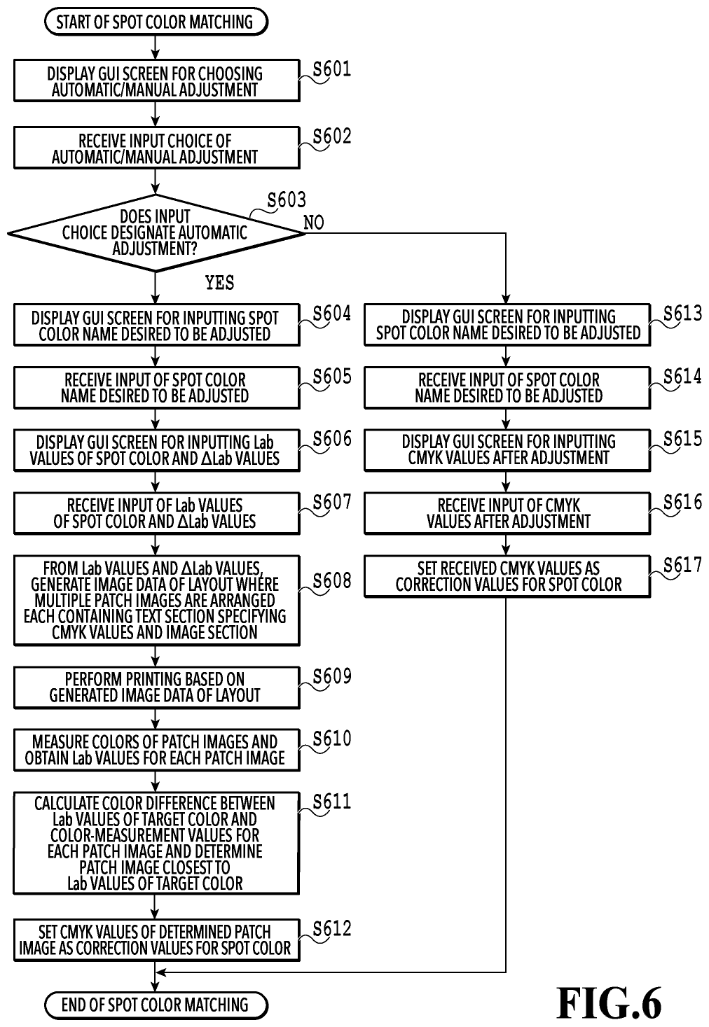

FIG. 3 presents GUI screens for spot color correction. The GUI screens presented in FIG. 3 are displayed on the display unit 26a of the operation display unit 26. A GUI screen 301 is a screen for choosing whether to make automatic color adjustment or manual color adjustment for spot color correction. In the case where the automatic color adjustment is chosen and a proceed button is pressed on the GUI screen 301, a GUI screen 302 is displayed. The user inputs L, a, and b values (referred to as Lab values) of a target color via the GUI screen 302 and also inputs ΔL, Δa, and Δb values (referred to as ΔLab values) for defining surrounding colors of the target color. The operation display unit 26 and the control unit 24 receive these inputs by the user. The target color and the surrounding colors will be described later in detail by using FIG. 4. In the case where the manual color adjustment is chosen and the proceed button is pressed on the GUI screen 301, a GUI screen 303 is displayed. The user inputs C, M, Y, and K values via the GUI screen 303. The operation display unit 26 and the control unit 24 receive these inputs by the user. Timings for displaying the GUI screen 301, the GUI screen 302, and the GUI screen 303 will be described later in detail by using FIG. 6.

FIG. 4 presents a lattice point group 400 representing a relationship between the target color and the surrounding colors. A center lattice point 401 represents L, a, and b of the target color. The center lattice point 401 will be referred to as a target color lattice point. Then, 26 surrounding lattice points whose positions are changed within a specified range from the reference lattice point 401 representing the target color represent the surrounding colors. In this case, a change in the position of each of the 26 lattice points is expressed by any of −ΔL, 0, +ΔL in a L direction, any of −Δa, 0, +Δa in an a direction, and any of −Δb, 0, +Δb in a b direction. These 26 lattice points will be referred to as surrounding color lattice points. The 27 lattice points representing the target color and the surrounding colors will be described later in detail by using FIG. 5. The L, a, and b values as well as the ΔL, Aa, and Ab values are input via the GUI screen 302 illustrated in FIG. 3.

FIG. 5 is a diagram illustrating the patch data of the device colors. The layout 501 is a layout in which patch images 502, which are images based on the patch data of the device colors, are arranged on a paper surface. This layout 501 is obtained by the image formation unit 22 performing printing based on the patch data of the device colors on the paper surface. In the present embodiment, as designated by ID1 to ID27 in FIG. 5, 27 patch images 502 are arranged in the layout 501.

A table 504 is a table for holding color information on each of the 27 patch images arranged in the layout 501. For example, ID14 is associated with the target color and the L, a, and b values input or received via the GUI screen 302 are written in a record ID14 in the table 504. As described above, the target color associated with ID14 is represented by the center lattice point 401 in FIG. 4. In contrast, ID1 to ID13 and ID15 to ID27 are associated with the surrounding colors. Regarding ID26, for example, values based on the L, a, and b values input or received via the GUI screen 302 and the ΔL, Δa, and Δb values input or received via the GUI screen 302 are written in reference to a record ID26 in the table 504. Specifically, L+ΔL is written as the L value, a+Δa is written as the a value, and b is written as the b value.

A patch image 503 presents specific contents actually printed in one patch image (ID27) among the 27 patch images 502 arranged in the layout 501. In each of the 27 patch images, the cyan, magenta, yellow, and black values of the printer device-dependent colors, and an image filled with the printer device-dependent colors specified by those values are printed as in the patch image 503. A combination of the cyan, magenta, yellow, and black values will be referred to as CMYK values. The inspection unit 27 measures the color in each of the images filled with the printer device-dependent colors, thereby obtaining the Lab values for each of ID1 to ID27.

FIG. 6 is a flowchart of spot color correction (color matching) processing, including a series of processes including a step of receiving a choice of whether to make automatic adjustment or manual adjustment before the patches for spot color correction are printed. In the following description, S represents a process (step) in the series of the flow.

In S601, the control unit 24 displays, on the display unit 26a of the operation display unit 26, a GUI screen for receiving an input of a choice of the automatic adjustment or the manual adjustment. The GUI screen 301 presented in FIG. 3 is an example of the GUI screen displayed in this step.

In S602, the control unit 24 receives an input of a choice of the automatic adjustment or the manual adjustment, which is a user's input via the GUI screen displayed in S601.

In S603, the control unit 24 determines whether the input of the choice received in S602 designates the automatic adjustment or not. In the case where the determination result in this step is true, the processing proceeds to S604. On the other hand, in the case where the determination result in this step is false, the processing proceeds to S613.

In S604, the control unit 24 displays, on the display unit 26a of the operation display unit 26, an input GUI screen for inputting a spot color name desired to be adjusted.

In S605, the control unit 24 receives the input of the spot color name designated via the GUI screen displayed in S604.

In S606, the control unit 24 displays, on the display unit 26a of the operation display unit 26, an input GUI screen for inputting the Lab values of the spot color and the ΔLab values. The GUI screen 302 presented in FIG. 3 is an example of the GUI screen displayed in this step.

In S607, the control unit 24 receives the input of the Lab values and the ΔLab values designated via the GUI screen displayed in S606.

In S608, based on the Lab values and the ΔLab values received in S607, the control unit 24 generates image data of a layout in which multiple patch images are arranged, each containing a text section indicating the CMYK values of the printer device-dependent colors and an image section filled with a single color. Specifically, the image data of the patch images is generated by calculating the CMYK values of the device-dependent colors based on the Lab values and the ΔLab values using the printer profile. In the example of FIG. 5, the image data of each of the patch images ID1 to ID27 is generated by calculating the CMYK values of the device-dependent colors using the printer profile based on the combination of the L value, the a value, and the b value for the ID concerned (held in the table 504). The image data of the layout 501 presented in FIG. 5 is an example of the image data of the layout generated in this step.

In S609, using the image formation unit 22, the control unit 24 prints the multiple patch images based on the image data of the layout generated in S608. In the example of FIG. 5, the 27 patch images 502 are printed.

In S610, the control unit 24 measures the colors in the filled images respectively contained in the multiple patch images printed in S609, thereby obtaining the color-measurement values (Lab values) of each of the multiple patch images. In the example of FIG. 5, the inspection unit 27 measures the color in each of the patch images ID1 to ID27, thereby obtaining the color-measurement values (Lab values) for each of ID1 to ID27.

In S611, the control unit 24 calculates a color difference between the Lab values of the target color received in S607 and the Lab values of each of the patch images obtained by the color-measurement in S610, and determines the patch image (ID) having the smallest color difference among the calculated color differences of the patch images. The color difference may be calculated by using CIEDE2000.

In S612, the control unit 24 sets the CMYK values of the device-dependent colors associated with the ID determined in S611 as correction values for a spot color specified by the spot color name received in S605, or in other words, stores the CMYK values in the storage unit 25 as the correction values.

In S613, the control unit 24 displays, on the display unit 26a of the operation display unit 26, an input GUI screen for inputting a spot color name desired to be adjusted.

In S614, the control unit 24 receives the input of the spot color name designated via the GUI screen displayed in S613.

In S615, the control unit 24 displays, on the display unit 26a of the operation display unit 26, an input GUI screen for inputting the CMYK values after the spot color correction. The GUI screen 303 presented in FIG. 3 is an example of the GUI screen displayed in this step.

In S616, the control unit 24 receives the input of the CMYK values designated via the GUI screen displayed in S615.

In S617, the control unit 24 sets the CMYK values received in S616 as the correction values for the spot color specified by the spot color name received in S614, or in other words, stores the CMYK values in the storage unit 25 as the correction values.

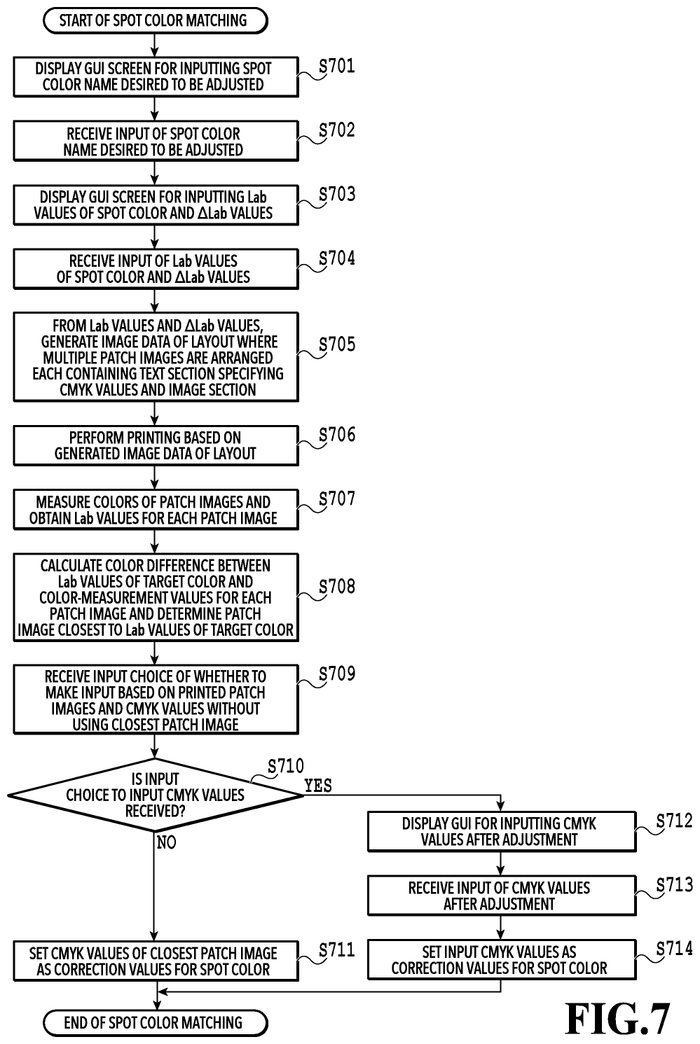

FIG. 7 is a flowchart of spot color correction (color matching) processing, including a series of processes including a step of receiving a choice of whether to make the automatic adjustment or the manual adjustment after the patches for spot color correction are printed.

In S701, the control unit 24 displays, on the display unit 26a of the operation display unit 26, an input GUI screen for inputting a spot color name desired to be adjusted.

In S702, the control unit 24 receives the input of the spot color name designated via the GUI screen displayed in S701.

In S703, the control unit 24 displays, on the display unit 26a of the operation display unit 26, an input GUI screen for inputting the Lab values of the spot color and the ΔLab values.

In S704, the control unit 24 receives the input of the Lab values and the ΔLab values designated via the GUI screen displayed in S703.

In S705, based on the Lab values and the ΔLab values received in S704, the control unit 24 generates image data of a layout in which multiple patch images are arranged, each containing a text section indicating the CMYK values of the printer device-dependent colors and an image section filled with a single color. This step is the same as S608 in FIG. 6.

In S706, using the image formation unit 22, the control unit 24 prints the multiple patch images based on the image data of the layout generated in S705.

In S707, the control unit 24 measures the colors in the filled images respectively contained in the multiple patch images printed in S609, thereby obtaining the color-measurement values (Lab values) of each of the multiple patch images. This step is the same as S610 in FIG. 6.

In S708, the control unit 24 calculates a color difference between the Lab values of the target color received in S704 and the Lab values of each of the patch images obtained by the color-measurement in S707, and determines the patch image (ID) having the smallest color difference among the calculated color differences of the patch images. The color difference may be calculated by using CIEDE2000.

In S709, the control unit 24 receives an input of a choice of whether to use the CMYK values input by the user based on the printed patch images and CMYK values of the printer device-dependent colors, without using the CMYK values of the patch image determined in S708.

In S710, the control unit 24 determines whether a choice to use the CMYK values input by the user based on the printed patch images and CMYK values of the printer device-dependent colors, without using the CMYK values of the patch image determined in S708 is received or not in S709. In the case where the determination result in this step is true, the processing proceeds to S712. On the other hand, in the case where the determination result in this step is false, the processing proceeds to S711.

In S711, the control unit 24 sets the CMYK values of the device-dependent colors associated with the ID determined in S708 as the correction values for the spot color specified by the spot color name received in S702, or in other words, stores the CMYK values in the storage unit 25 as the correction values.

In S712, the control unit 24 displays, on the display unit 26a of the operation display unit 26, an input GUI screen for inputting the CMYK values of the printer device-dependent colors.

In S713, the control unit 24 receives an input of the CMYK values of the printer device-dependent colors designated via the GUI screen displayed in S712.

In S714, the control unit 24 sets the CMYK values received in S713 as the correction values for the spot color specified by the spot color name received in S702, or in other words, stores the CMYK values in the storage unit 25 as the correction values.

### Effect of Present Embodiment

In the present embodiment, in the case of the automatic adjustment, the Lab values and the ΔLab values input by the user are received, and the layout in which the multiple patch images are arranged, each containing the text section indicating the CMYK values of the printer device-dependent colors and the image section filled with a single color, is printed. Then, the CMYK values (device-dependent colors) associated with the patch image having the smallest color difference are set as the correction values for the spot color specified by the spot color name. On the other hand, in the case of the manual adjustment, the above layout is printed as in the case of the automatic adjustment, but the user is prompted to choose a desired patch image among the printed patch images, and the CMYK values associated with the chosen patch image as the correction values for the spot color specified by the spot color name. This configuration achieves highly-accurate spot color correction.

### Second Embodiment

In the present embodiment, the user is prompted to confirm whether or not to re-execute the spot color correction under a predetermined condition.

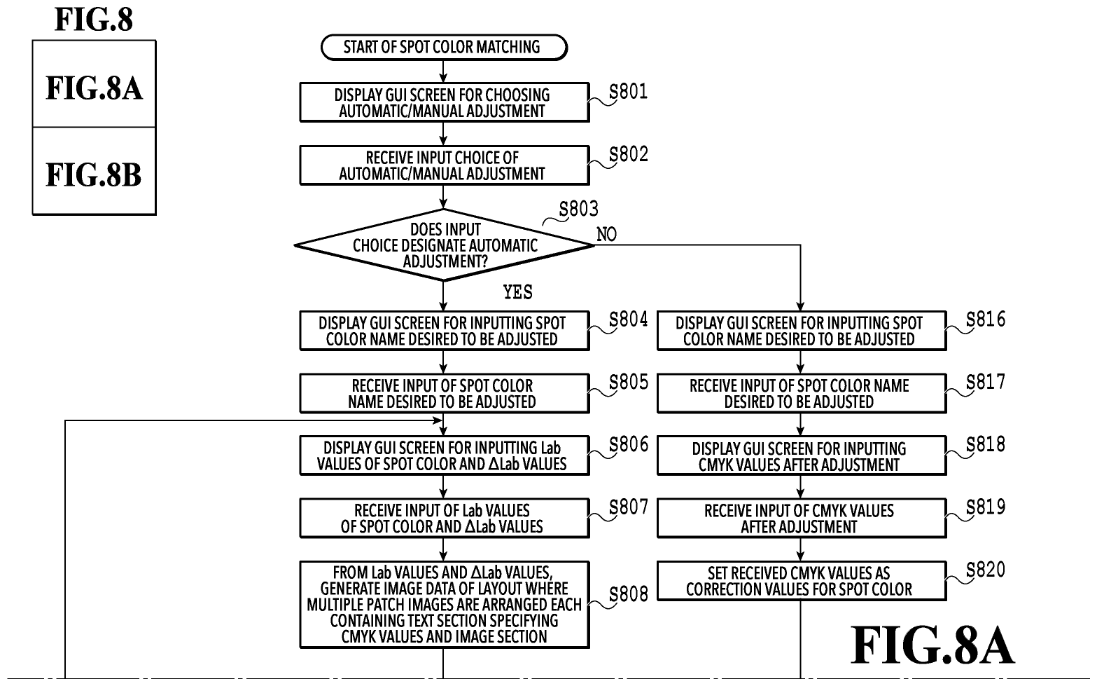

FIG. 8 is a diagram showing the relationship of FIG. 8A and FIG. 8B, and FIG. 8A and FIG. 8B collectively show a flowchart of spot color correction (color matching) processing, including a series of processes including a step of prompting the user to confirm whether or not to re-execute the spot color correction under the predetermined condition.

In S801, the control unit 24 displays, on the display unit 26a of the operation display unit 26, a GUI screen for receiving an input of a choice of the automatic adjustment or the manual adjustment. The GUI screen 301 presented in FIG. 3 is an example of the GUI screen displayed in this step.

In S802, the control unit 24 receives an input of a choice of the automatic adjustment or the manual adjustment, which is a user's input via the GUI screen displayed in S801.

In S803, the control unit 24 determines whether the input of the choice received in S802 designates the automatic adjustment or not. In the case where the determination result in this step is true, the processing proceeds to S804. On the other hand, in the case where the determination result in this step is false, the processing proceeds to S816.

In S804, the control unit 24 displays, on the display unit 26a of the operation display unit 26, an input GUI screen for inputting a spot color name desired to be adjusted.

In S805, the control unit 24 receives the input of the spot color name designated via the GUI screen displayed in S804.

In S806, the control unit 24 displays, on the display unit 26a of the operation display unit 26, an input GUI screen for inputting the Lab values of the spot color and the ΔLab values. The GUI screen 302 presented in FIG. 3 is an example of the GUI screen displayed in this step.

In S807, the control unit 24 receives the input of the Lab values and the ΔLab values designated via the GUI screen displayed in S806.

In S808, based on the Lab values and the ΔLab values received in S807, the control unit 24 generates image data of a layout in which multiple patch images are arranged, each containing a text section indicating the CMYK values of the printer device-dependent colors and an image section filled with a single color. Specifically, the image data of the patch images is generated by calculating the CMYK values of the device-dependent colors based on the Lab values and the ΔLab values using the printer profile. In the example of FIG. 5, the image data of each of the patch images ID1 to ID27 is generated by calculating the CMYK values of the device-dependent colors using the printer profile based on the combination of the L value, the a value, and the b value for the ID concerned (held in the table 504). The image data of the layout 501 illustrated in FIG. 5 is an example of the image data of the layout generated in this step.

In S809, using the image formation unit 22, the control unit 24 prints the multiple patch images based on the image data of the layout generated in S808. In the example of FIG. 5, the 27 patch images are printed.

In S810, the control unit 24 measures the colors in the filled images respectively contained in the multiple patch images printed in S809, thereby obtaining the color-measurement values (Lab values) of each of the multiple patch images. In the example of FIG. 5, the inspection unit 27 measures the color in each of the patch images ID1 to ID27, thereby obtaining the color-measurement values (Lab values) for each of ID1 to ID27.

In S811, the control unit 24 calculates a color difference between the Lab values of the target color received in S807 and the Lab values of each of the patch images obtained by the color-measurement in S810, and determines the patch image (ID) having the smallest color difference among the calculated color differences of the patch images. The color difference may be calculated by using CIEDE2000.

In S812, the control unit 24 judges whether the color-measurement values (Lab values) of the patch image determined in S811 fall within the limits of a three-dimensional shape defined by the surrounding pixels obtained by adding or subtracting the ΔLab values received in S807 to or from the Lab values received in S807. Specifically, as illustrated in FIG. 4, it is judged whether the color-measurement values for the ID determined in S811 fall within the limits of the rectangular parallelepiped defined by the lattice point group including the target color lattice point and the 26 surrounding color lattice points. In the case where the judgment result in this step is true, the processing proceeds to S815. On the other hand, in the case where the judgment result in this step is false, the processing proceeds to S813.

In S813, the control unit 24 displays, on the display unit 26a of the operation display unit 26, a GUI screen for receiving an input of a choice of whether or not to re-execute the automatic adjustment, and receives an input of a choice of whether or not to re-execute the automatic adjustment, which is a user's input via the displayed GUI screen.

In S814, the control unit 24 determines whether the re-execution of the automatic adjustment is chosen or not via the GUI screen displayed in S813. In the case where the determination result in this step is true, the processing proceeds to S806. On the other hand, in the case where the determination result in this step is false, the processing proceeds to S815.

In S815, the control unit 24 sets the CMYK values of the device-dependent colors associated with the ID determined in immediately previous S811 as the correction values for the spot color specified by the spot color name received in S805, or in other words, stores the CMYK values in the storage unit 25 as the correction values.

In S816, the control unit 24 displays, on the display unit 26a of the operation display unit 26, an input GUI screen for inputting a spot color name desired to be adjusted.

In S817, the control unit 24 receives the input of the spot color name designated via the GUI screen displayed in S816.

In S818, the control unit 24 displays, on the display unit 26a of the operation display unit 26, an input GUI screen for inputting the CMYK values after the spot color correction. The GUI screen 303 presented in FIG. 3 is an example of the GUI screen displayed in this step.

In S819, the control unit 24 receives the input of the CMYK values designated via the GUI screen displayed in S818.

In S820, the control unit 24 sets the CMYK values received in S819 as the correction values for the spot color specified by the spot color name received in S817, or in other words, stores the CMYK values in the storage unit 25 as the correction values.

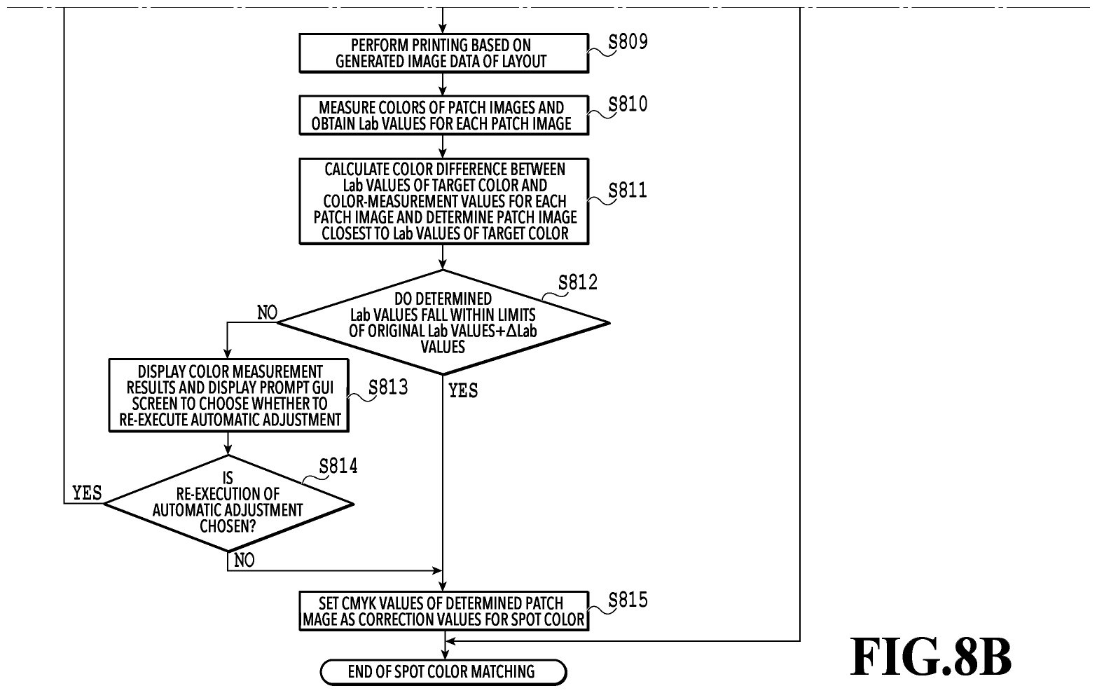

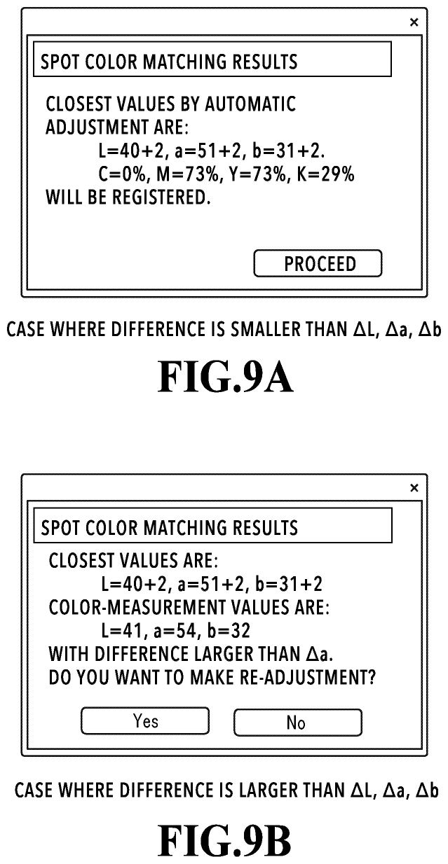

FIGS. 9A and 9B present examples of GUI screens on which spot color correction results are presented to the user. These GUI screens are displayed on the display unit 26a of the operation display unit 26. FIG. 9A is an example of a GUI screen that presents the user only with the results of the automatic adjustment, without including a message to confirm whether or not to re-execute the spot color correction, that is, a screen displayed in the case where the judgment in S812 results in YES. On the other hand, FIG. 9B is an example of a GUI screen that is displayed at the timing in S813 and that includes not only the results of the automatic adjustment but also a message to confirm whether or not to re-execute the spot color correction, that is, a GUI screen displayed in the case where the judgment in S812 results in NO.

### Effect of Present Embodiment

In the present embodiment, the GUI screen for prompting the user to confirm whether or not to re-execute the spot color correction under the predetermined condition is displayed and the user viewing the GUI screen determines to re-execute the spot color correction as needed. This makes it possible to prevent the correction values after the spot color correction from greatly deviating from the target values.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, highly-accurate spot color correction can be achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-009202, filed Jan. 25, 2024, which is hereby incorporated by reference wherein in its entirety.

What is claimed is:

1. An image forming apparatus comprising:
a reception unit configured to receive first Lab values of a target color and ΔLab values;
a generation unit configured to generate image data of a layout in which a plurality of patch images are arranged based on the first Lab values and the ΔLab values using a printer profile, the plurality of patch images each containing an image section filled with a single color;
a formation unit configured to form the plurality of patch images on a print medium based on the image data of the layout;
an obtaining unit configured to measure a color in the image section of each of the plurality of patch images formed by the formation unit and thereby obtain second Lab values for each of the plurality of patch images;
a determination unit configured to determine the patch image, the second Lab values for which are closest to the first Lab values of the target color, among the plurality of patch images; and
a setting unit configured to set CMYK values of the patch image determined by the determination unit as correction values for a spot color.

2. The image forming apparatus according to claim 1, wherein
each of the plurality of patch images contains a text section in which CMYK values of device-dependent colors are written, and
the CMYK values set as the correction values by the setting unit are the CMYK values written in the text section in the patch image determined by the determination unit.

3. The image forming apparatus according to claim 1, wherein
each of the plurality of patch images is associated with any of the target color and surrounding colors of the target color.

4. The image forming apparatus according to claim 3, further comprising:
a display unit configured to display a GUI screen; and
a display control unit configured to display the GUI screen on the display unit, wherein
the display control unit displays a first GUI screen on the display unit, the first GUI screen prompting a user to choose whether to make automatic adjustment or manual adjustment for the spot color.

5. The image forming apparatus according to claim 4, wherein the display control unit displays a second GUI screen on the display unit, the second GUI screen prompting the user to input a spot color name desired to be adjusted.

6. The image forming apparatus according to claim 5, further comprising a judgment unit configured to judge whether the second Lab values of the patch image determined by the determination unit fall within the limits of a rectangular parallelepiped defined by a lattice point group including the target color and the surrounding colors, wherein
in a case where the judgment unit judges the second Lab values do not fall within the limits, the display control unit displays a third GUI screen on the display unit, the third GUI screen prompting the user to choose whether or not to re-execute automatic adjustment for the spot color.

7. The image forming apparatus according to claim 6, wherein the lattice point group includes one target color lattice point representing the target color and 26 surrounding color lattice points representing the surrounding colors.

8. The image forming apparatus according to claim 7, wherein in a case where the re-execution of the automatic adjustment for the spot color is chosen via the third GUI screen, the automatic adjustment for the spot color is re-executed.

9. An image forming apparatus control method comprising:
a reception step of receiving first Lab values of a target color and ΔLab values;
a generation step of generating image data of a layout in which a plurality of patch images are arranged based on the first Lab values and the ΔLab values using a printer profile, the plurality of patch images each containing an image section filled with a single color;
a formation step of forming the plurality of patch images on a print medium based on the image data of the layout;
an obtaining step of measuring a color in the image section of each of the plurality of patch images formed in the formation step and thereby obtaining second Lab values for each of the plurality of patch images;
a determination step of determining the patch image, the second Lab values for which are closest to the first Lab values of the target color, among the plurality of patch images; and
a setting step of setting CMYK values of the patch image determined in the determination step as correction values for a spot color.

10. A non-transitory computer readable storage medium storing a program causing a computer to execute an image forming apparatus control method comprising:
a reception step of receiving first Lab values of a target color and ΔLab values;
a generation step of generating image data of a layout in which a plurality of patch images are arranged based on the first Lab values and the ΔLab values using a printer profile, the plurality of patch images each containing an image section filled with a single color;
a formation step of forming the plurality of patch images on a print medium based on the image data of the layout;
an obtaining step of measuring a color in the image section of each of the plurality of patch images formed in the formation step and thereby obtaining second Lab values for each of the plurality of patch images;
a determination step of determining the patch image, the second Lab values for which are closest to the first Lab values of the target color, among the plurality of patch images; and
a setting step of setting CMYK values of the patch image determined in the determination step as correction values for a spot color.
